(19) United States
(12) Patent Application Publication
(10) Pub. No.: US 2015/0012663 A1
(43) Pub. Date: Jan. 8, 2015

(54) INCREASING A DATA TRANSFER RATE

(71) Applicants: Nanivadekar Mandar, Bangalore Karnataka (IN); Kulkarni Rohan, Bangalore Karnataka (IN); Bhat Naveen, Bangalore Karnataka (IN)

(72) Inventors: Nanivadekar Mandar, Bangalore Karnataka (IN); Kulkarni Rohan, Bangalore Karnataka (IN); Bhat Naveen, Bangalore Karnataka (IN)

(21) Appl. No.: 14/375,526

(22) PCT Filed: Apr. 26, 2012
(86) PCT No.: PCT/US2012/035174

§ 371 Date: Jul. 30, 2014

(51) Int. Cl. H04L 29/08

(52) U.S. Cl. CPC H04L 67/06
USPC 709/233

(57) ABSTRACT

A system and method for increasing a data transfer rate are provided herein. The method includes receiving a data buffer from an application and splitting data within the data buffer into a number of data packets. The method also includes adding metadata to each data packet and transferring each of the data packets in parallel across network links to a destination.

### BACKGROUND

As information management becomes more prevalent, the amount of data generated and stored within computing environments continues to grow at an astounding rate. With data doubling approximately every eighteen months, network bandwidth becomes a limiting factor for data intensive applications like data backup agents. Additionally, the transfer of large amounts of data over networks of limited bandwidth presents scalability issues. Modern day servers are preinstalled with as many as four network interface cards (NICs) with a provision for adding more network interfaces. However, such servers generally do not effectively use all of the network connections provided by the NICs.

### BRIEF DESCRIPTION OF THE DRAWINGS

Certain examples are described in the following detailed description and in reference to the drawings, in which:

FIG. 1 is a block diagram of a client computing device that may be used in accordance with examples;

FIG. 2 is a schematic of a computing system that may be used to increase a data transfer rate, in accordance with examples;

FIG. 3 is a block diagram of the computing system, in accordance with examples;

FIG. 4 is a process flow diagram showing a method for increasing a data transfer rate, in accordance with examples; and

FIG. 5 is a block diagram showing a tangible, non-transitory, computer-readable medium that stores a protocol adapted to increase a data transfer rate, in accordance with examples.

### DETAILED DESCRIPTION OF SPECIFIC EXAMPLES

As discussed above, current systems and methods for performing data transfer operations typically do not use all of the available network connections, or links. For example, a computing device may include four network links. However, the computing device may use only a primary network link to transfer data. This may result in a slow data transfer rate. In addition, when the primary network link becomes full, the transfer of data may be limited. Meanwhile, other network links may remain idle or underutilized.

Systems and methods described herein relate generally to techniques for increasing a rate of transferring data between computing devices. More specifically, systems and methods described herein relate to the effective use of idle or under-utilized network links by an application within a computing environment. The use of such network links may result in performance improvements, such as faster data transfer when compared to the scenario where the under-utilized network links remain under-utilized. Additionally, the balanced use of the network links may improve the network data transfer performance. As used herein, a balanced network is a network that has the flow of data at an expected speed across the network links, without long-term congestion or under-utilization of network links. Furthermore, such network links can be used to provide fault tolerance, thus reducing the likelihood that data transfer processes, such as backup and restore processes, within the computing environment will fail.

According to the techniques described herein, load balanced data transfer operations may be implemented across multiple network links with dissimilar network speeds and varying network loads. This may be accomplished using an application, such as a backup or restore application, that is linked with a load balancing socket library. As used herein, a library is a collection of program resources for the applications of a client computing system. The library may include various methods and subroutines. For example, the load balancing socket library may include subroutines for the concurrent transfer of data using multiple network interface cards (NICs). The transfer is accomplished by using the load balancing socket library, without any change in the code of the application.

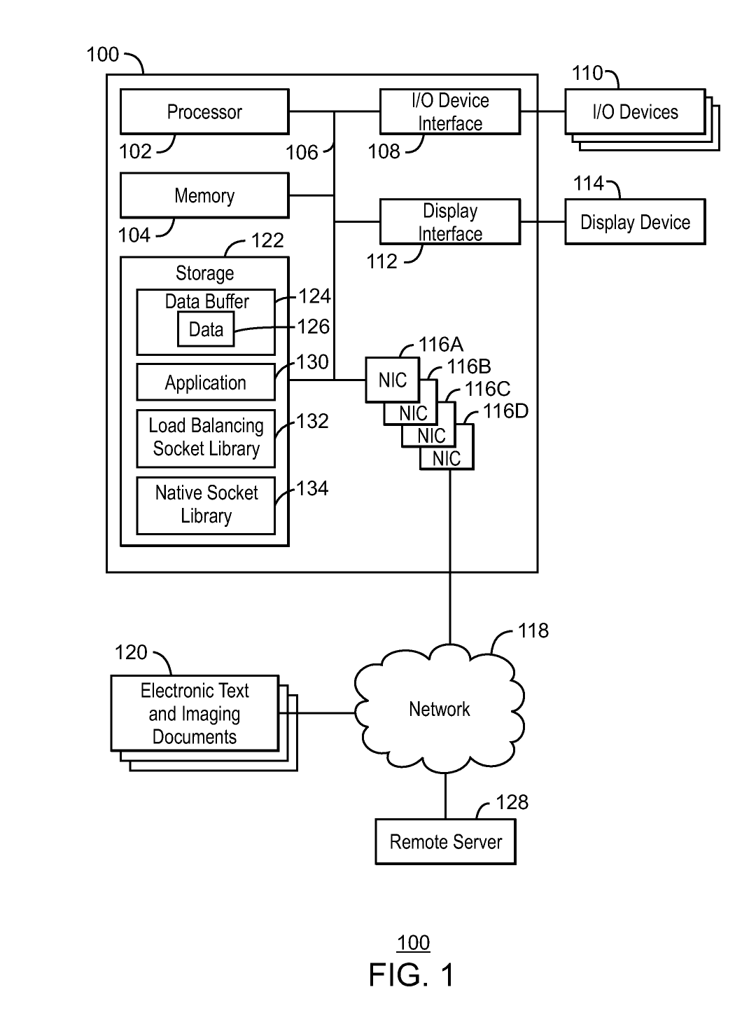

FIG. 1 is a block diagram of a client computing device 100 that may be used in accordance with examples. The client computing device 100 may be any type of computing device that is capable of sending and receiving data, such as a server, mobile phone, laptop computer, desktop computer, or tablet computer, among others. The client computing device 100 may include a processor 102 that is adapted to execute stored instructions, as well as a memory device 104 that stores instructions that are executable by the processor 102. The processor 102 can be a single core processor, a multi-core processor, a computing cluster, or any number of other configurations. The memory device 104 can include random access memory (RAM), read only memory (ROM), flash memory, or any other suitable memory systems. The instructions that are executed by the processor 102 may be used to implement a method that includes splitting data within a data buffer into multiple data packets, adding metadata to the data packets, and transferring the data packets in parallel across network links to another computing device.

The processor 102 may be connected through a bus 106 to an input/output (I/O) device interface 108 adapted to connect the client computing device 100 to one or more I/O devices 110. The I/O devices 110 may include, for example, a keyboard and a pointing device, wherein the pointing device may include a touchpad or a touchscreen, among others. Furthermore, the I/O devices 110 may be built-in components of the client computing device 100, or may be devices that are externally connected to the client computing device 100.

The processor 102 may also be linked through the bus 106 to a display interface 112 adapted to connect the client computing device 100 to a display device 114. The display device 114 may include a display screen that is a built-in component of the client computing device 100. The display device 114 may also include a computer monitor, television, or projector, among others, that is externally connected to the client computing device 100.

Multiple NICs 116 may be adapted to connect the client computing device 100 through the bus 106 to a network 118. In various examples, the client computing device 100 includes four NICs 116A, 116B, 116C, and 116D, as shown in FIG. 1. However, it will be appreciated that any suitable number of NICs 116 may be used in accordance with examples. The network 118 may be a wide area network (WAN), local area network (LAN), or the Internet, among others. Through the network 118, the client computing device 100 may access electronic text and imaging documents 120. The client computing device 100 may also download the electronic text and imaging documents 120 and store the electronic text and imaging documents 120 within a storage device 122 of the client computing device 100.

The storage device 122 can include a hard drive, an optical drive, a thumbdrive, an array of drives, or any combinations thereof. The storage device 122 may include a data buffer 124 containing data 126 to be transferred to another computing device via the network 118. The data buffer 124 may be a region of physical memory storage within the storage device 122 that temporarily stores the data 126. In some examples, the data 126 is transferred to a remote server 128 via the network 118. The remote server 128 may be a datacenter or any other type of computing device that is configured to store the data 126.

The transfer of the data 126 across the network 118 may be accomplished using an application 130 that is linked to a load balancing socket library 132, as discussed further below. The application 130 and the load balancing socket library 132 may be stored within the storage device 122. In addition, the storage device 122 may include a native socket library 134 that provides standard functionalities for transferring the data 126 across the network 118. In some examples, the functionalities of the load balancing socket library 132 may be included within the native socket library 134, and the load balancing socket library 132 may not exist as a distinct library within the client computing device 100.

Further, in some examples, data may be transferrred from the remote server 128 to the client computing device 100 via the network 118. In such examples, the received data may be stored within the storage device 122 of the client computing device 100.

In various examples, the load balancing socket library 132 within the client computing device 100 provides for an increase in a data transfer rate for data transfer operations by implementing a load balancing procedure. According to the load balancing procedure, the load balancing socket library 132 may split the data 126 within the data buffer 124 into a number of data packets (not shown). As used herein, the term “data packet” refers to a formatted unit of data that may be transferred across a network. In addition, the load balancing socket library 132 may utlize any number of the NICs 116 to transfer the data packets across the network 118 to the remote server 128.

It is to be understood that the block diagram of FIG. 1 is not intended to indicate that the client computing device 100 is to include all of the components shown in FIG. 1. Further, the client computing device 100 may include any number of additional components not shown in FIG. 1, depending on the design details of a specific implementation.

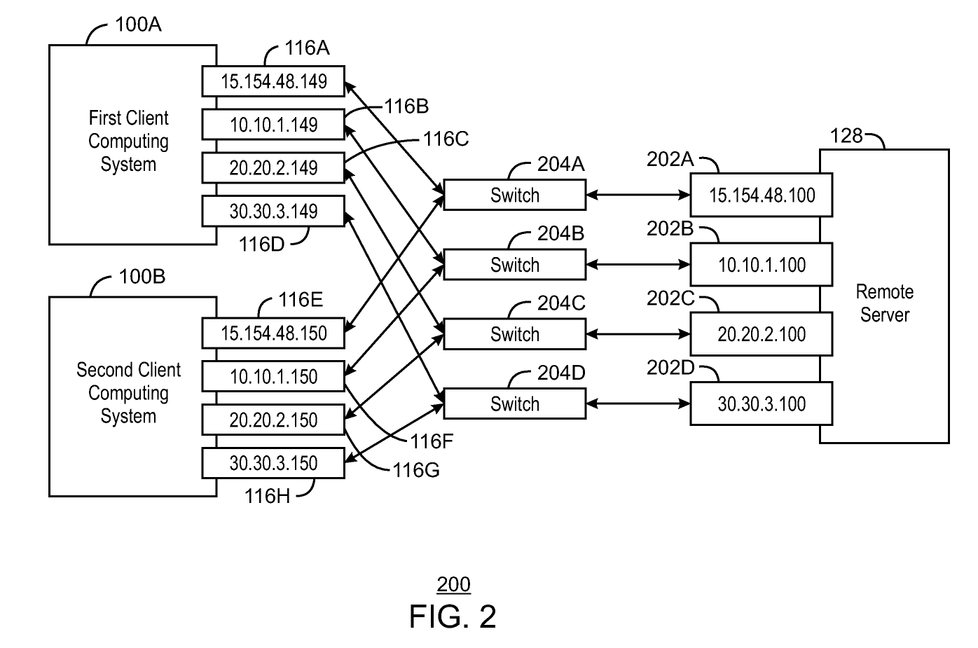

FIG. 2 is a schematic of a computing system 200 that may be used to increase a data transfer rate, in accordance with examples. Like numbered items are as described with respect to FIG. 1. The computing system 200 may include any number of client computing devices 100, including a first client computing device 100A and a second client computing device 100B, as shown in FIG. 1. The computing system 200 may also include the remote server 128, or any number of remote servers 128, that are communicatively coupled to the client computing devices 100 via the network 118.

As shown in FIG. 2, the client computing device 100A may include four NICs 116A, 1168, 116C, and 116D. Additionally, the client computing device 100B may include four NICs 116E, 116F, 116G, and 116H. However, as mentioned above, each of the client computing devices 100A and 100B may include any suitable number of NICs 116, and may include different numbers of NICs. Each of the NICs 116A, 116B, 116C, 116D, 116E, 116F, 116G, and 116H may include a distinct internet protocol (IP) address that is used to provide host or network interface identification, as well as location addressing. For example, the NICs 116A, 116B, 116C, and 116D within the first client computing device 100A may include the IP addresses “15.154.48.149,” “10.10.1.149,” “20.20.2.149,” and “30.30.3.149,” respectively. The NICs 116E, 116F, 116G, and 116H within the second client computing device 100B may also include distinct IP addresses, as shown in FIG. 2. The IP address of each NIC 116 enables metadata to be added to the transferred data that identifies the origin of the transferred data.

The remote server 128 may also include a number of NICs 202. For example, as shown in FIG. 2, the remote server 128 may include four NICs 202A, 202B, 202C, and 202D. In addition, the NICs 202A, 202B, 2020, and 202D may be located at the IP addresses “15.154.48.100,” “10.10.1.100,” “20.20.2.100,” and “30.30.3.100,” respectively.

A number of switches, e.g., network switches or network hubs, 204 may be used to communicatively couple the NICs 116 within the client computing devices 100 to the NICs 202 within the remote server 128 via the network 118. The computing system 200 may include any suitable number of the switches 204. For example, as shown in FIG. 2, the computing system 200 may include four switches 204A, 204B, 204C, and 204D. In other examples, the computing system 200 may include one switch 204 with a number of ports for connecting to multiple different NICs 116 and 202.

In various examples, one possible route of communication between one of the client computing devices 100 and the remote server 128 may be referred to as a “network link.” For example, the NIC 116A within the first client computing device 100A, the corresponding switch 204A, and the corresponding NIC 202A within the remote server 128 may form one network link within the computing system 200. This network link may be considered the primary network link between the client computing device 100A and the remote server 128. Accordingly, data may be transferred between the client computing device 100A and the remote server 128 using this primary network link.

As shown in FIG. 2, multiple alternate network links may exist between the client computing devices 100 and the remote server 128. According to techniques described herein, data may be transferred from the first client computing device 100A or the second client computing device 100B to the remote server 128 using any number of the alternate network links. The use of a number of network links, rather than only the primary network link, may result in an increase in the rate of data transfer for the computing system 200.

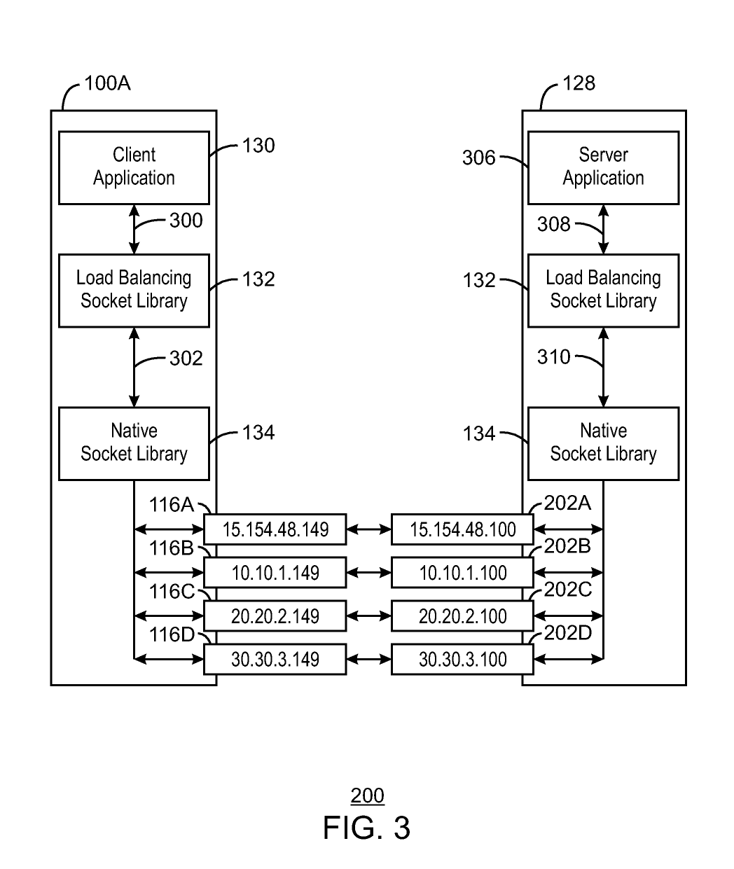

FIG. 3 is a block diagram of the computing system 200, in accordance with examples. Like numbered items are as described with respect to FIGS. 1 and 2. The block diagram shown in FIG. 3 is a simplified representation of the computing system 200. However, it is to be understood that the computing system 200 shown in FIG. 3 includes the same network links as shown in FIG. 2, including the switches 204. Further, it is to be understood that, while FIG. 2 is discussed below with respect to the first client computing device 100A, the techniques described herein are equally applicable to the second client computing device 100B.

As shown in FIG. 2, the client application 130 and the load balancing socket library 132 may be communicatively coupled within the first client computing device 100A, as indicated by arrow 300. In various examples, the client application 130 may include, for example, a backup application or a restore application. In addition, the load balancing socket library 132 and the native socket library 134 may be communicatively coupled within the first client computing device 100A, as indicated by arrow 302.

In various examples, the remote server 128 includes a server application . 306, as well as a copy of the load balancing socket library 132 and the native socket library 134. The server application 306 may be, for example, a backup application or a restore application. The server application 306 and the load balancing socket library 132 may be communicatively coupled within the remote server 128, as indicated by arrow 308. The load balancing socket library 132 and the native socket library 134 may also be communicatively coupled within the remote server 128, as indicated by arrow 310. In some examples, one or both of the load balancing socket library 132 and the native socket library 134 may include functionalities that are specific to the remote server 128. Thus, the load balancing socket library 132 and the native socket library 134 within the remote server 128 may not be exact copies of the load balancing socket library 132 and the native socket library 134 within the first client computing device 100A.

In various examples, the load balancing socket library 132 is configured to balance a load for data transfer across each of the alternate network links. In examples, the load balancing socket library 132 includes information regarding the speed and capacity of each network link. When splitting data from a data buffer in order to transfer the load across a network using load balanced transfer, the load balancing socket library 132 can analyze the size of the data packet with respect to the speed and capacity of each network link. In this manner, the size of the data packet may be optimized for the network link on which the data packet will travel. This may result in an increase of the data transfer rate, as each data packet is optimized for the attributes of the network link on which the data packet travels. In examples, such an optimization procedure is particularly applicable to networks with dissimilar network speeds or varying network traffic, or both.

In addition, the load balancing socket library may be configured to provide policies for the transfer of information between two communicating endpoints, e.g., the first client computing device 100A and the remote server 128. Such policies may include, for example, IP addresses and port numbers for the switch 204. The load balancing socket library 132 may also provide traditional socket library interfaces, such as send( ), receive( ), bind( ), listen( ), and accept( ), among others.

In some examples, the load balancing socket library 132 is a separate library that operates in conjunction with the native socket library 134. In such examples, the addition of the load balancing socket library 132 does not result in any changes to the native socket library 134. In other examples, the functionalities of the load balancing socket library 132 are included directly within the native socket library 134.

The client application 130 and the server application 306 may each link with their respective instances of the load balancing socket library 132 in order to take advantage of multiple NICs 116 and 202 for data transfer and fault tolerance. In some cases, this may be accomplished without any change in the program code of the client application 130 or the server application 306.

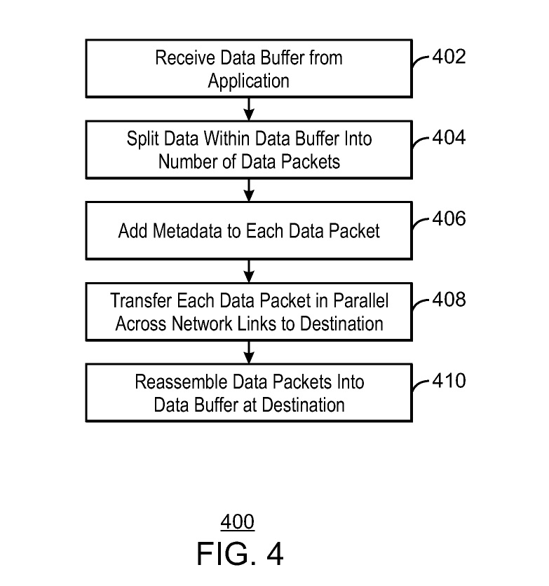

The client application 130 and the server application 306 may initially communicate via the primary network link, e.g. the network link including the NICs 116A and 202A. However, the load balancing socket library 132 may dynamically determine if alternate network links exist between the first client computing device 100A and the remote server 128. If alternate network links are present between the two communicating devices, the load balancing socket library 132 may establish and use the alternate network links, in addition to the primary network link, for the transfer of data. Thus, the data within a data buffer to be transferred may be split into a number of data packets, and metadata may be added to each data packet, as discussed further below with respect to the method 400 of FIG. 4. Further, once the data packets have been transferred across the network links, the load balancing socket library 132 may be configured to reassemble the data packets into the original data buffer.

The load balancing socket library 132 may provide fault tolerance by detecting failed or busy network links and redirecting network traffic based on the alternate network links that are available. Further, the load balancing socket library 132 may compensate for differences in network speed across network links by splitting the data within the data buffer in such a way as to achieve a high throughput. For example, a smaller data packet may be transferred via a slow network link, while a larger data packet may be transferred via a fast network link. In this manner, the data transfer is dynamically optimized based on the available network links.

FIG. 4 is a process flow diagram showing a method 400 for increasing a data transfer rate, in accordance with examples. The method 400 may be implemented within the computing system 200 discussed above with respect to FIGS. 1-3. For example, the client that is utilized according to the method 400 may be the client computing device 100A or 1008, while the server that is utilized according to the method 400 may be the remote server 128.

The method 400 may be implemented via a library that is configured to perform the steps of the method 400. In some examples, the library may be the load balancing socket library 132 described above with respect to FIGS. 1-3. In other examples, the library may be a modified form of the native socket library 134 described above with respect to FIGS. 1-3.

The method begins at block 402, at which a data buffer is received from an application within the client. The application may be any type of application or program for transferring data, such as, for example, a backup application or a restore application. The data buffer may include data that is to be transferred from the client to the server.

At block 404, the data within the data buffer is split into a number of data packets. This may be performed in response to determining that alternate network links exist between the client and the server. The data within the data buffer may be split into a number of data packets based on the number of alternate network links that are available, the number of under-utilized network links, or the varying network speeds of different network links, or any combinations thereof.

At block 406, metadata is added to each data packet. The metadata that is added to each data packet may be tracking metadata including a header that denotes the order or sequence that the data within the data packet was obtained from the data buffer. The header may include a unique data buffer sequence number and a UTC timestamp that indicates the time at which the data packet was packaged and sent. The unique data buffer sequence number allows the data packets to be reassembled in the correct order once the data packets reach their destination, as discussed further below. Additionally, the header may also include an offset value that describes the appropriate location of each data packet within the data buffer, a length of each data packet, and a checksum of the data buffer. The offset value and length of the data packet allows the data packet to be transferred to its destination in the same position relative to its position in the original data buffer. Further, the checksum allows the transfer of data to be fault tolerant by providing a random block of data that may be used to detect errors in the data transmission process. In addition, the checksum may be used for integrity checking of the data.

At block 408, each data packet is transferred in parallel across network links to a destination. In various examples, the server is the destination. While the data packets may be transferred in parallel, each of the network links may operate with varying network speeds. Thus, the data packets may be determined such that the load across each network link is balanced. For example, the transfer of each data packet may be self-adjusted to increase throughput when compared to transferring each data packet without adjustment. As used herein, self-adjusted refers to the ability of the load balancing socket library to select the size of each data packet relative to the status of the network links. The status of the network links refers to any congestion or under-utilization of network links that occurs within the networks. Accordingly, the transfer of the data packets across the network links may be load balanced.

At block 410, the data packets are reassembled at the destination to obtain the original block of data from the original data buffer. The tracking metadata may be used to ensure that the data packets are reassembled in the correct order at the destination. Thus, in various examples, the data is not altered by the data transfer process. This may be particularly useful for implementations in which the transferred data is to maintain the same characteristics as the original data, such as, for example, backup operations or restore operations.

The process flow diagram of FIG. 4 is not intended to indicate that blocks 402-406 are to be executed in any particular order, or that all of the blocks to be included in every case. Further, any number of additional processes may be included within the method 400, depending on the specific implementation.

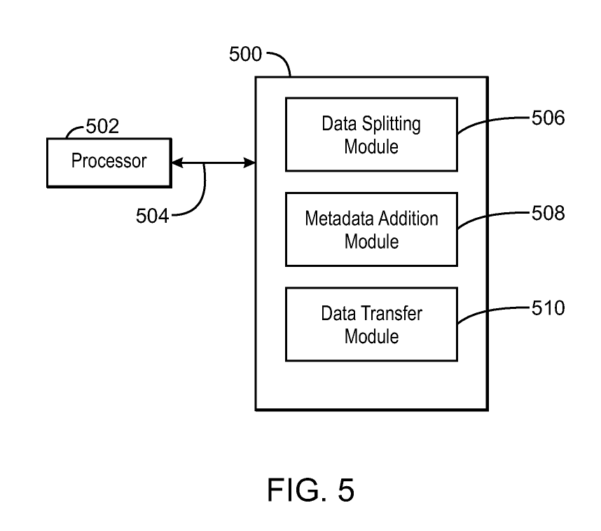

FIG. 5 is a block diagram showing a tangible, non-transitory, computer-readable medium 500 that stores a protocol adapted to increase a data transfer rate, in accordance with examples. The computer-readable medium 500 may be accessed by a processor 502 over a computer bus 504. Furthermore, the computer-readable medium 500 may include code to direct the processor 502 to perform the steps of the current method.

The various software components discussed herein may be stored on the tangible, non-transitory, computer-readable medium 500, as indicated in FIG. 5. For example, a data splitting module 506 may be configured to direct the processor 502 to split data within a data buffer into a number of data packets depending on a number of alternate network links that are available for transferring the data. A metadata addition module 508 may be configured to direct the processor 502 to add tracking metadata to each data packet. In addition, a data transfer module 510 may be configured to direct the processor 502 to transfer each data packet in parallel across the network links to another computing device, such as a server or datacenter.

It is to be understood that FIG. 5 is not intended to indicate that all of the software components discussed above are to be included within the tangible, non-transitory, computer-readable medium 500 in every case. Further, any number of additional software components not shown in FIG. 5 may be included within the tangible, non-transitory, computer-readable medium 500, depending on the specific implementation. For example, a data buffer assembly module may be configured to combine any number of received data packets to produce a new data buffer.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A computer-implemented method for increasing a data transfer rate, comprising:
receiving data from an application;
splitting the data into a plurality of data packets;
adding metadata to each of the plurality of data packets; and
transferring each of the plurality of data packets in parallel across network links to a destination.

2. The computer-implemented method of claim 1, wherein a library is created that operates to split the data within a data buffer into the plurality of data packets, add metadata to each of the plurality of data packets, and transfer each of the plurality of data packets in parallel to the destination.

3. The computer-implemented method of claim 1, comprising:
receiving the plurality of data packets at the destination; and
assembling the plurality of data packets into a received data buffer at the destination.

4. The computer-implemented method of claim 1, wherein a native socket library is modified to split the data within a data buffer into the plurality of data packets, add the metadata to each of the plurality of data packets, and transfer each of the plurality of data packets in parallel to the destination.

5. The computer-implemented method of claim 1, comprising transferring each of the plurality of data packets in parallel across the network links to the destination, wherein the network links operate with varying network speeds.

6. The computer-implemented method of claim 1, wherein the transfer of each of the plurality of data packets is self-adjusted to increase throughput when compared to transferring each of the plurality of data packets without adjustment.

7. The computer-implemented method of claim 1, wherein transferring each of the plurality of data packets in parallel to the destination is fault tolerant.

8. The computer-implemented method of claim 1, wherein a load across each network link is balanced.

9. A system for increasing a data transfer rate, comprising:
a processor that is adapted to execute stored instructions; and
a storage device that stores instructions, the storage device comprising processor executable code that, when executed by the processor, is adapted to:
determine alternate network links between a client and a server;
receive data from the client;
split the data into a plurality of data packets;
add metadata to each of the plurality of data packets; and
transfer each of the plurality of data packets in parallel across the alternate network links to the server.

10. The system of claim 9, comprising:
receiving the plurality of data packets at the server; and
assembling the plurality of data packets into a received data buffer at the server.

11. The system of claim 9, wherein a native socket library is modified to determine the alternate network links between the client and the server, receive the data from the client, split the data into the plurality of data packets, add the metadata to each of the plurality of data packets, and transfer each of the plurality of data packets in parallel across the alternate network links to the server.

12. The system of claim 9, comprising transferring each of the plurality of data packets in parallel across the network links to the server, wherein the network links operate with varying network speeds.

13. The system of claim 9, wherein the transfer of each of the plurality of data packets is self-adjusted to increase throughput when compared to transferring each of the plurality of data packets without adjustment.

14. The system of claim 9, wherein transferring each of the plurality of data packets in parallel to the server is fault tolerant.

15. A tangible, non-transitory, computer-readable medium comprising code to direct a processor to:
split data into a plurality of data packets;
add metadata to each of the plurality of data packets; and
transfer each of the plurality of data packets in parallel across network links to a destination.
